(19) United States
(12) Patent Application Publication
(10) Pub. No.: US 2016/0167216 A1
(43) Pub. Date: Jun. 16, 2016

(54) TOOL HANDLE

(71) Applicant: Yu-Hua OU, Taichung City (TW)

(72) Inventor: Yu-Hua OU, Taichung City (TW)

(21) Appl. No.: 14/570,729

(22) Filed: Dec. 15, 2014

(51) Int. Cl. B25G 1/10; B25G 3/02

(52) U.S. Cl. CPC B25G 1/10; B25G 3/02

(57) ABSTRACT

A tool handle is provided for a tool rod to insert therein. A connecting end of the tool rod is formed with a mark portion. The tool handle includes a grip body, a cover layer and a perspective layer. The grip body is disposed around the connecting end and includes a window portion corresponding to the mark portion. The cover layer partially covers the grip body and exposes the window portion. The cover layer is softer than the grip body. The perspective layer is disposed on the window portion and includes at least one convex lens portion corresponding to the mark portion.

### BACKGROUND OF THE INVENTION

1. Field of the Invention

The present invention relates to a grip, and more particularly to a tool handle.

2. Description of the Prior Art

Because of growth of mechanical industry, hand tools applying for different components are becoming more. The hand tool is usually formed with a mark portion. The mark portion is usually processed by printing or pasting, and a logo or criteria of the hand tool can be displayed.

Nevertheless, though the hand tool is formed with the mark portion on a surface, a graphic of the mark portion is usually worn down by hands after using in a long time, and the mark portion is indistinct. Besides, in order to save cost, the tool handle is usually injected and formed by only one material, and the grip is integrally solid. It is uncomfortable for a user to use in a long time.

The present invention has arisen to mitigate and/or obviate the afore-described disadvantages.

### SUMMARY OF THE INVENTION

The primary object of the present invention is to provide a tool handle. The tool handle is disposed around a tool rod formed with a mark portion and includes a window portion so that a user can see an inside of the tool handle from outside. The mark portion is untouched by the user, and the mark portion is hard to wear down. Besides, the window portion is provided with a convex lens portion so that the mark portion is enlarged, and the tool handle is easy to be identified.

Furthermore, the tool handle is covered by a soft cover layer. The tool handle is fit to hands and it is comfortable for the user to use.

To achieve the above object, a tool handle in accordance with present invention is provided, for a tool rod to insert therein. A connecting end of the tool rod is formed with a mark portion. The tool handle includes a grip body, a cover layer and a perspective layer. The grip body is disposed around the connecting end and includes a window portion corresponding to the mark portion. The cover layer partially covers the grip body and exposes the window portion. The cover layer is softer than the grip body. The perspective layer is disposed on the window portion and includes at least one convex lens portion corresponding to the mark portion.

### BRIEF DESCRIPTION OF THE DRAWINGS

FIGS. 1-2 are three-dimensional drawings of a preferable embodiment of the present invention;

FIG. 3 is a breakdown drawing of the preferable embodiment of the present invention;

FIG. 4 is a perspective drawing of the preferable embodiment of the present invention;

FIG. 5 is a cross-sectional drawing of the preferable embodiment of the present invention;

FIG. 6 is a partial cross-sectional drawing of the preferable embodiment of the present invention;

FIG. 7 is a partial cross-sectional drawing of another preferable embodiment of the present invention.

### DETAILED DESCRIPTION OF THE PREFERRED EMBODIMENTS

The present invention will be clearer from the following description when viewed together with the accompanying drawings, which show, for purpose of illustrations only, the preferred embodiment in accordance with the present invention.

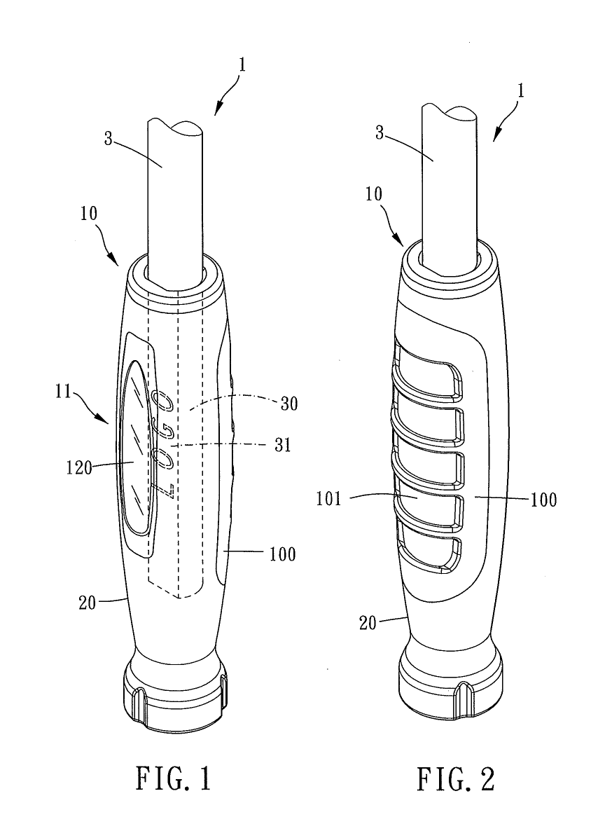

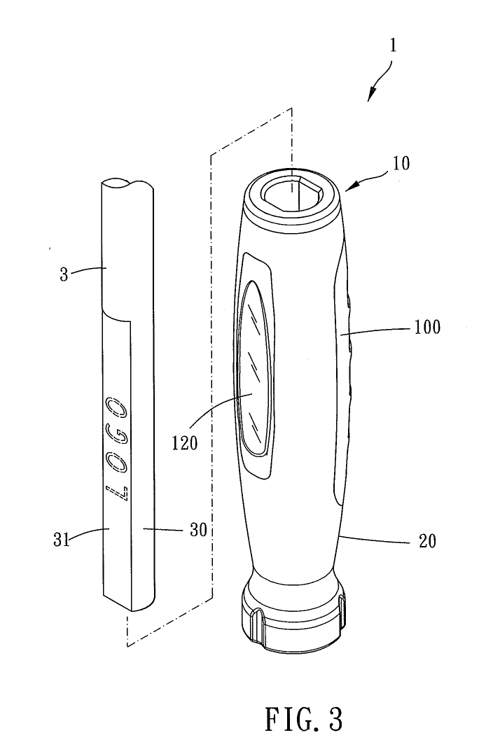

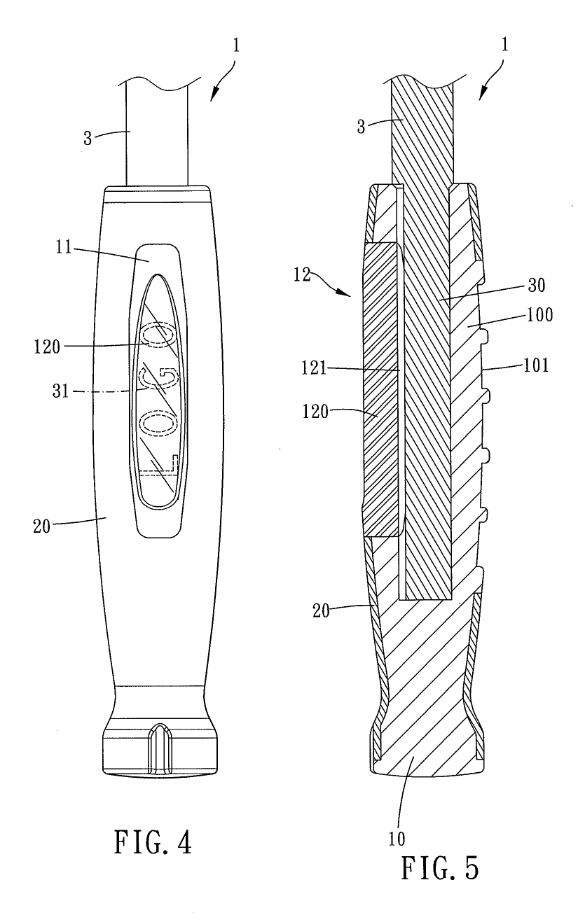

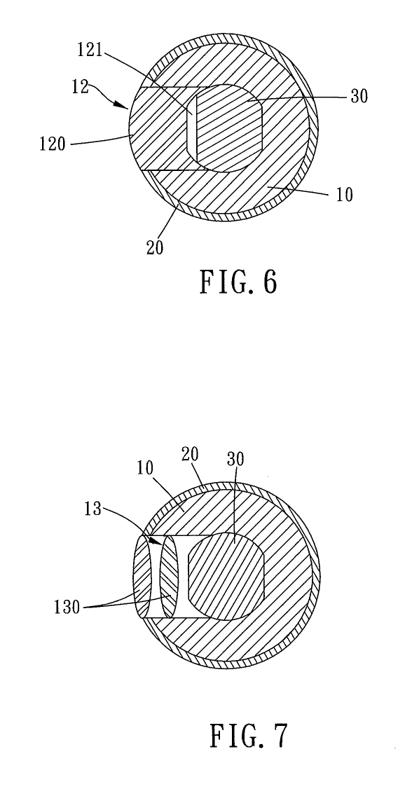

Please refer to FIGS. 1-6, a tool handle 1 in accordance with a preferable embodiment of the present invention is provided for a tool rod 3 to insert therein. A connecting end 30 of the tool rod 3 is formed with a mark portion 31. The tool handle 1 includes a grip body 10, a cover layer 20 and a perspective layer 12. In the present embodiment, the mark portion 31 of the connecting end 30 is a flat surface so that the mark portion 31 is assembled with the tool rod 3 fitly and printed easily. Moreover, a cross section of the connecting end 30 can be circular, rectangular or can have other shapes.

The grip body 10 is disposed around the connecting end 30 and includes a window portion 11 corresponding to the mark portion 31. The mark portion 31 is seen through the window portion 11. Moreover, the perspective layer 12 is disposed on the window portion 11 and includes at least one convex lens portion 120 corresponding to the mark portion 31, and a graphic of the mark portion 31 is enlarged. In the present embodiment, a whole of the perspective layer 12 is formed as the convex lens portion 120. Specifically, the grip body 10 is formed with a concave slot and the perspective layer 12 is engagingly disposed in the concave slot. It is noted that the grip body and the perspective layer can be formed integrally. Moreover, a gap 121 is formed between the mark portion 31 and the perspective layer 12. In other embodiments, the mark portion 31 and the perspective layer 12 can be abutted against each other directly. The tool rod 3 is more steadily inserted in the grip body 10.

In another embodiment, as shown in FIG. 7, a perspective layer 13 can be engagingly provided with two convex lens portions 130. The two convex lens portions 130 correspond to the mark portion 31, and the perspective layer 13 has a better result in enlarging the graphic. It is noted that the perspective layer can be engagingly provided with more convex lens portions, or every portion of the mark portion can respectively correspond to one said convex lens portion.

Please refer to FIGS. 1-6 again, the cover layer 20 partially covers the grip body 10 and exposes the window portion 11. The cover layer 20 is softer than the grip body 10. Moreover, the cover layer 20 is substantially deformed and fit to a hand when a user holds it, and it is comfortable for the user to hold and use. Preferably, the cover layer 20 can be made of ventilating material, and the user is hard to sweat in hands after a long time of using. In the present embodiment, the cover layer 20 is in a first color, and the grip body 10 is in a second color. The first color is different from the second color so that the tool handle 1 is easily identified. It is noted that the first and second colors can be the same.

In the present embodiment, the grip body 10 further includes a grip portion 100. The grip portion 100 includes a plurality of recesses 101 so that the user can hold it steadily and it is hard to slip off from the hand of the user. It is noted that the grip body can be formed without the grip portion, and the grip body 10 can be covered by a material with high friction or rough structures, and it is also stable for operating.

As a conclusion, the tool handle of the present invention is embeddingly provided with the mark portion, and the graphic of the mark portion is hard to wear down. Moreover, the tool handle is further provided with the convex lens portion on the window portion, and when the user sees through the convex lens portion, the graphic is enlarged and the tool handle is easy to be identified.

Moreover, the tool handle is covered by the soft cover layer, and it is comfortable for the user to hold and use.

Besides, the tool handle further includes the grip portion, and it is stable for the user to hold and operate and it is hard to slip off form the user.

While we have shown and described various embodiments in accordance with the present invention, it should be clear to those skilled in the art that further embodiments may be made without departing from the scope of the present invention.

What is claimed is:

1. A tool handle, for a tool rod to insert therein, a connecting end of the tool rod formed with a mark portion, the tool handle comprising:
a grip body, disposed around the connecting end and including a window portion corresponding to the mark portion;
a cover layer, partially covering the grip body and exposing the window portion, the cover layer softer than the grip body;
a perspective layer, disposed on the window portion, including at least one convex lens portion corresponding to the mark portion.

2. The tool handle as claimed in claim 1, wherein the mark portion is a flat surface.

3. The tool handle as claimed in claim 1, wherein a gap is formed between the mark portion and the perspective layer.

4. The tool handle as claimed in claim 1, wherein the mark portion and the perspective layer are abutted against each other.

5. The tool handle as claimed in claim 1, wherein the grip body includes a grip portion, and the grip portion includes a plurality of recesses.

6. The tool handle as claimed in claim 1, wherein a whole of the perspective layer is formed as the convex lens portion.

7. The tool handle as claimed in claim 1, wherein the cover layer is in a first color, the grip body is in a second color, and the first color is different from the second color.

8. The tool handle as claimed in claim 1, wherein the cover layer is in a first color, the grip body is in a second color, and the first and second colors are the same.
